(19) United States
(12) Patent Application Publication
(10) Pub. No.: US 2026/0250143 A1
(43) Pub. Date: Aug. 27, 2026

(54) LITHIUM RECOVERY FROM WASTEWATER

(71) Applicant: Worcester Polytechnic Institute, Worcester, MA (US)

(72) Inventors: Yan Wang, North Andover, MA (US); Zeyi Yao, Worcester, MA (US); Jiahui Hou, Worcester, MA (US)

(21) Appl. No.: 19/538,323

(22) Filed: Feb. 12, 2026

Related U.S. Application Data
(60) Provisional application No. 63/762,795, filed on Feb. 25, 2025.

(51) Int. Cl. C01D 15/08; B01D 15/08; B01D 65/02; B01D 69/02; B01J 20/06; C02F 1/00; C02F 1/28; C02F 1/44; C02F 1/66; C02F 101/10; C02F 103/10; C02F 103/16; C22B 3/02; C22B 3/24; C22B 3/42; C22B 26/12

(52) U.S. Cl. CPC C01D 15/08; B01D 15/08; B01D 65/02; B01D 69/02; B01J 20/06; C02F 1/001; C02F 1/281; C02F 1/44; C02F 1/66; C22B 3/02; C22B 3/24; C22B 3/42; C22B 26/12; B01D 2325/42; C01P 2006/80; C02F 2101/10; C02F 2103/10; C02F 2103/16; C02F 2209/06; C02F 2301/046; C02F 2303/16

(57) ABSTRACT

Lithium is extracted from natural brine or manufactured sources by adsorbing lithium on a lithium-selective solid medium, acid-washing to form a low-concentration lithium solution, concentrating the solution using a lithium-ion-conducting polymer membrane, and precipitating lithium carbonate from the concentrated lithium solution. The low concentration lithium solution is concentrated by flowing the low concentration lithium solution across a lithium-ion-conducting polymer membrane, and acid washing the lithium-ion-conducting polymer membrane to generate a concentrated lithium solution. Purified lithium is extracted by precipitating lithium from the concentrated lithium solution.

### RELATED APPLICATIONS

This patent application claims the benefit under 35 U.S.C. § 119(e) of U.S. Provisional Patent App. No. 63/762,795, filed Feb. 25, 2025, entitled “LITHIUM RECOVERY FROM WASTEWATER,” incorporated herein by reference in entirety.

### BACKGROUND

Rising adoption of electric vehicles and grid-scale storage is accelerating demand for lithium, while domestic supply in the United States remains limited. Closing this gap will require utilizing non-traditional resources such as low-grade brines, where lithium occurs at low concentrations amid overwhelming levels of sodium, magnesium, and calcium. Although many extraction technologies can selectively capture lithium, they often produce a stripping solution that is still too diluted and/or too contaminated for rapid, low-energy manufacture of battery-grade lithium carbonate. Conventional solar evaporation is slow and geographically constrained, and many direct lithium extraction (DLE) routes still depend on energy-intensive concentration or multi-step purification to meet product specifications.

### SUMMARY

Lithium is extracted from brine or manufactured sources by adsorbing lithium on a lithium-selective solid medium, acid-washing to form a low-concentration lithium solution. The low concentration lithium solution is concentrated by flowing the low concentration lithium solution across a lithium-ion-conducting polymer membrane, and acid washing the lithium-ion-conducting polymer membrane to generate a concentrated lithium solution. Purified lithium is extracted by precipitating lithium from the concentrated lithium solution.

Configurations herein are based, in part, on the observation that widespread adoption of Li-ion batteries require large quantities of raw materials including anode and cathode materials formed from critical materials such as nickel, cobalt, manganese and lithium. Unfortunately, conventional approaches to battery production suffer from the shortcoming that the alkali materials such as lithium are in the form of salts that are difficult to extract in a pure form without substantial impurities and/or other comingled metal salts. Further, conventional processes typically resort to high temperature or pyrometallurgical techniques which tend to mitigate energy and cost savings. Although lithium is a common denominator of most battery chemistries, it can be problematic to extract pure, battery grade (>99.5% purity) lithium.

Concurrently, rising adoption of electric vehicles and grid-scale storage is accelerating the demand for lithium, while domestic supply in many regions remains limited. Closing this gap will require utilizing non-traditional resources such as low-grade brines, where lithium occurs at low concentrations amid overwhelming levels of sodium, magnesium, and calcium. Although many extraction technologies can selectively capture lithium, they often produce a stripping solution that is still too diluted and/or too contaminated for rapid, low-energy manufacture of battery-grade lithium carbonate. Conventional solar evaporation is slow and geographically constrained, and many direct lithium extraction (DLE) routes still depend on energy-intensive concentration or multi-step purification to meet product specifications.

Accordingly, configurations herein substantially overcome the shortcomings of conventional lithium production by providing highly pure lithium composition in the form of lithium carbonate, a form typically employed in manufacturing of Li-ion batteries. The selective transport of cations provided by the lithium selective solid medium, lithium-ion-conducting polymer membrane, and precipitates provides highly purified lithium carbonate suitable for battery manufacture. An energy-efficient selective lithium extraction process couples a zirconium-titanate ion-sieve sorbent for lithium-selective capture with a lithium-ion-conducting polymer-based membrane (LiCPM) for non-thermal concentration, followed by direct carbonation to Li₂CO₃. Alternatively, an electrodialysis process enabled by a selective membrane including a solid-state electrolyte (SSE), such as lithium lanthanum zirconium oxide (LLZO) or lithium aluminum titanium phosphate (LATP) may be employed.

In further detail, a method for harvesting lithium as disclosed herein includes adsorbing lithium by a lithium selective solid medium from a brine, and extracting a low concentration lithium solution by acid washing the lithium selective solid medium. The low concentration lithium solution is concentrated into a lithium rich solution by flowing the low concentration lithium solution across a lithium-ion-conducting polymer membrane, and acid washing the lithium-ion-conducting polymer membrane to generate a concentrated lithium solution. Precipitation of lithium from the concentrated lithium solution yields highly pure lithium carbonate.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of a production environment suitable for use with configurations herein;

FIGS. 2A-2E show adsorption performance of zirconium-titanate based lithium-ion sieves over a range of pH values;

FIGS. 3A-3H show use cases Li concentration, including extracting and releasing lithium from the lithium-ion-conducting polymer-based membrane (LiCPM); and

FIGS. 4A-4E clarify the dependencies of precipitation performance exhibited clear on temperature, pH, and time.

### DETAILED DESCRIPTION

In configurations depicted below, lithium production operations employ selective adsorption by zirconium-titanate based lithium-ion sieves for extracting lithium cations from brine or aqueous waste solutions, while disfavoring adsorption of impurities. Concentration by a lithium-ion-conducting polymer-based membrane provides non-thermal (low temperature) fast Li enrichment. Acidic dissolution and precipitation through carbonation and pH adjustment yields highly pure lithium carbonate suitable for use with new recycled battery cells.

Lithium has become a defining material of electrification because it underpins the dominant rechargeable battery chemistries for electric vehicles and grid storage. In some research scenarios, lithium demands are projected to grow roughly eightfold by 2040, underscoring the scale of supply expansion required within a single industrial cycle. Parallel to demand growth, lithium supply and refining remain geographically concentrated, and recent government and corporate strategies increasingly frame lithium as a critical mineral tied to supply-chain resilience and industrial competitiveness. These dynamics have accelerated interest in expanding lithium production beyond conventional hard-rock and saline operations toward diverse brine resources, including high-salinity continental brines, geothermal brines, and oil-and-gas produced waters. Yet these resources are often “chemically difficult”: lithium occurs at low-to-moderate concentrations in the presence of overwhelming Na⁺/K⁺ backgrounds, multivalent interferents (Mg²⁺ and Ca²⁺), and scale-forming anions, making selectivity, energy intensity, and robustness decisive for commercial feasibility.

Historically, lithium production from brines relied on solar evaporation to concentrate Li⁺ prior to chemical conversion. Although mature evaporation is geographically constrained and intrinsically slow, it can also magnify impurity burdens as brine concentrates, complicating downstream purification and raising scrutiny around water, chemical inputs, and management of spent brines. It should be emphasized that salinity refers to concentration of salts of any metal, not just sodium chloride (NaCl), which is commonly equated with salinity. These constraints are amplified when targeting high-salinity aqueous feeds beyond saline ponds, where rapid, controllable, and energy-efficient concentration must be achieved without relying on climatic conditions. This challenge has helped drive the emergence of direct lithium extraction (DLE) as a family of technologies intended to shorten residence time, reduce land footprint, and broaden the accessible resource base.

Within DLE, the technical landscape now spans solvent extraction, adsorption/ion-sieve capture, membrane-based separations (including electrodialysis and dialysis-derived schemes), and electrochemical intercalation approaches. Among these routes, two coupled bottlenecks repeatedly appear for low-grade and high-salinity feeds. The first is achieving true lithium selectivity at practical kinetics and stability under high ionic strength, where electrostatic screening weakens many “charge-based” selectivity mechanisms and where Na⁺/K⁺ competition and multivalent scaling can dominate. The second is that even when selective capture is successful, the product stream is often still too dilute or too impure for economic conversion to battery-grade lithium chemicals, meaning that a downstream concentration and purification step frequently becomes the hidden determinant of overall energy consumption and process viability.

Configurations disclosed and claimed herein emphasize that adsorption and ion-sieve approaches represent one of the most scalable front-end options because they can, in principle, encode Li⁺ preference through crystallographic “fit” and dehydration penalties rather than relying solely on electrostatic partitioning. In general, an ion sieve is a highly selective, porous adsorbent material—typically a metal oxide or aluminosilicate—engineered to separate specific ions from solutions based on size and charge. It acts on a molecular level to allow target ions to enter its pores while excluding larger ones, effectively purifying or concentrating desired ions. Titanium-based lithium-ion sieves, in particular, have attracted renewed attention due to their chemical stability and tunable structures, and recent reviews emphasize continued progress in understanding adsorption mechanisms and improving practical cycling performance. However, the literature also makes clear that strong apparent selectivity in simplified solutions does not automatically translate to robust operation in real high-salinity matrices. Competitive uptake from abundant monovalent ions, slowed mass transfer under high ionic strength, and degradation during regeneration remain recurring concerns, and comprehensive assessments of DLE sustainability and performance highlight that many studies still rely on synthetic feeds that underrepresent real-brine complexity. These realities point to the need for sorbent platforms that are not only selective in principle but also engineered for durable cycling and high throughput under harsh brine conditions.

The downstream concentration step is equally decisive. Electrodialysis (ED) and related membrane processes can concentrate lithium salts at ambient temperature, but ED performance in complex brines is often constrained by limited Li⁺ selectivity over competing cations, membrane fouling, and scaling, while bipolar membrane configurations add pH control but can increase energy demands and stability challenges.

Carbonation-based conversion of the solution to battery-grade lithium carbonate (Li₂CO₃) imposes exceptionally stringent requirements on purity and impurity control, yet many DLE routes struggle to meet these standards consistently and comprehensively in practice. Carbonation itself can be chemically straightforward, but it is unforgiving to impurity carryover; residual Mg²⁺/Ca²⁺, sulfate/carbonate equilibria, and coprecipitation pathways can degrade product purity and reduce yield, turning upstream high recovery into downstream operational complexity. The DLE review literature increasingly recognizes that the middle step, creating a carbonate-ready lithium stream through efficient concentration and impurity control, often determines whether a process can realistically deliver battery-grade products. This perspective motivates an integrated architecture in which selective extraction and non-thermal concentration are designed together, rather than treating concentration as a generic utility.

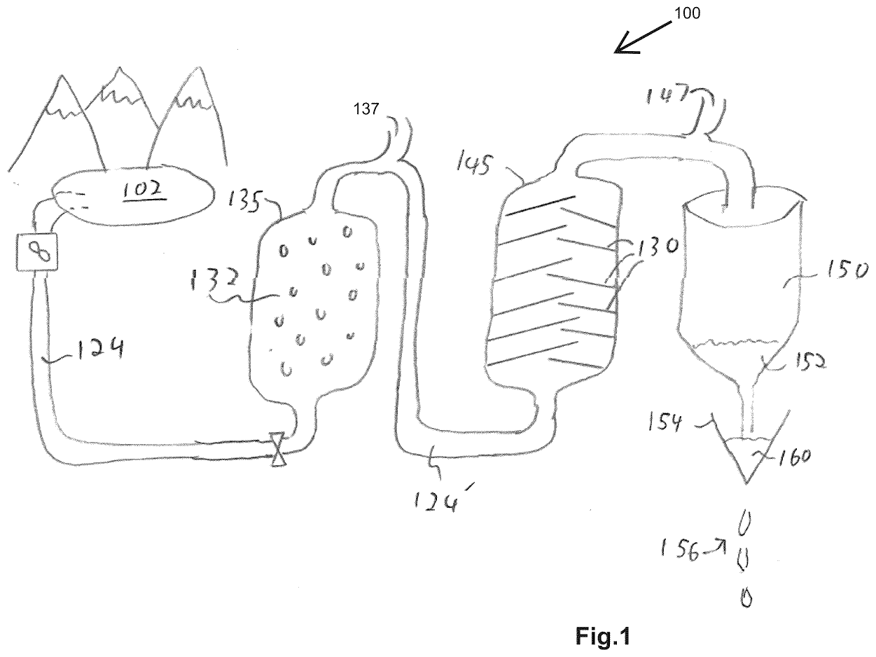

FIG. 1 is a context diagram of a production environment 100 for lithium harvesting or extraction. Referring to FIG. 1 a method of generating purified lithium includes adsorbing lithium onto a lithium-selective solid medium 132 from an aqueous stream 124. A column, packed bed or similar aggregation of the lithium-selective solid medium for fluidic passage and communication may be employed, optionally with a distributor configured to provide upflow or downflow liquid distribution through the packed bed. In the production environment 100, the aqueous stream may be generated from a naturally occurring harvested brine solution 102 having dissolved lithium, or other suitable source, such as from wastewater downstream of a Li-ion battery recycling operation. In general, any suitable aqueous solution including dissolved lithium may be employed.

The highly selective solid medium 132 performs extraction of lithium while leaving impurities behind. This may include passing the brine through a column of the solid medium responsive to lithium for forming an adsorbed lithium medium. An example configuration includes forming the lithium selective solid medium 132 by doping a titanium oxide with zirconium, forming the zirconium-titanate ion-sieve sorbent. The solid medium 132 may be deployed in a column or canister 135 that receives the aqueous stream 124 at an input and discharges impurities and waste at a discharge 137. Alternatively, the feedwater may be iteratively cycled to ensure complete adsorption by the solid medium 132.

Following the adsorption of Li onto the solid medium 132, a first acid flows across the lithium-selective solid medium 132 for extracting a low concentration lithium solution 124′. The first acid may be hydrochloric (HCl) or other suitable acid for binding with the Li on the solid medium without damaging the sorbent and forming the low concentration lithium solution. As described above, concentration of the dissolved lithium is problematic to scale to production levels in conventional approaches. Accordingly, concentration as disclosed herein includes passing the low concentration lithium solution 124′ contacting a lithium-ion-conducting polymer membrane 130 for extracting or loading the lithium onto the lithium-ion-conducting polymer membrane 130. The membrane 130 may be formed into a layered or chevron arrangement in a subsequent containment, stack or column 145, however any suitable immersion, flowing, or fluidic engagement establishes the contacting of the membrane 130 with the low concentration solution 124′ may be employed. At this stage, the low concentration lithium solution 124′ has a concentration between 0.001-0.1 M.

The membrane binds or adsorbs lithium in the low concentration solution 124′, as the remaining solution 147 may be recycled, treated, or discharged. Concentration includes flowing a second acid and contacting the lithium-ion-conducting polymer membrane for extracting a concentrated lithium solution 150, or lithium rich solution. In an example configuration, the concentrated lithium solution has a concentration between 0.5 and 5.0 M, roughly two to three orders of magnitude greater than the concentration of the yield from the solid medium. An example configuration employs H₂SO₄ as the second acid, however any suitable acid for releasing the Li from the membrane 130 may be employed.

In a recovery phase, lithium forms from precipitation 152 of the concentrated lithium solution 150 in a reactor or similar containment. The disclosed approach adds sodium carbonate for precipitating lithium carbonate. Sodium hydroxide may also be added to increase the pH for precipitation.

Therefore, the concentrated lithium solution from the containment 145 releases a lithium rich solution 150, followed by lithium precipitation, typically as lithium carbonate. Precipitation may include increasing the pH of the concentrated lithium solution 150, and adding a carbonate for precipitating the lithium in the form of lithium carbonate. A particular example employs sodium hydroxide (NaOH) for increasing pH, followed by sodium carbonate for precipitation such that the strong base and the carbonate are both sodium compounds. A filter 154 filters the precipitate 152 to extract the lithium carbonate precipitate product 160, and the filtrate 156 may be retained or reused for successive cycles. Similarly, a regeneration loop configured to deliver an acid solution to release lithium and deliver a rinse solution to restore the lithium-selective solid medium and/or the lithium-ion-conducting polymer membrane for subsequent cycles. Various refinements and alternatives are discussed in the use cases below.

Configurations herein develop the environment above into an integrated, product-oriented route for energy-efficient selective lithium extraction and room-temperature concentration from high-salinity aqueous feeds. The particular example process above couples a zirconium-titanate ion-sieve sorbent (Zirconium-Titanate Ion-Sieve 01, ZTIS-01) for lithium-selective capture with a lithium-ion-conducting polymer-based membrane (LiCPM) for non-thermal concentration, followed by direct carbonation to Li₂CO₃. A particular objective is to demonstrate that pairing a robust solid-phase selectivity engine 132 with a lithium-conducting membrane 130 transport step can overcome a pervasive failure mode in brine processing: although many extraction schemes achieve high lithium recovery, the resulting eluate often remains too dilute and/or too contaminated with Na⁺/K⁺ and multivalent impurities to enable economic conversion to battery-grade lithium carbonate. The disclosed process is therefore explicitly “carbonate-ready” by design, treating downstream qualification constraints as the primary performance target rather than an afterthought; each upstream decision, material selection, operating conditions, and regeneration strategy, is assessed by how effectively it drives the solution composition toward the concentration and impurity envelope required for high-purity Li₂CO₃ precipitate 160.

In retrospect, the disclosed approach contributes a broader conceptual advance for direct lithium extraction: selectivity and concentration are intentionally decoupled yet engineered to be synergistic. ZTIS-01 serves as a selective adsorbent front-end that is designed to remain functional under high ionic strength, where conventional charge-based separations often lose discrimination and where fouling and scaling risks are elevated. LiCPM, in turn, acts as a room-temperature concentration back-end that leverages cations conductor design principles to concentrate Li⁺, compressing the operational complexity typically required to reach carbonate-ready conditions. By integrating these two functions, the disclosed approach addresses a recurring gap emphasized in conventional DLE approaches: performance claims frequently center on recovery and selectivity metrics at the extraction step, while offering limited evidence for a credible, energy-lean pathway to concentrated, impurity-controlled solutions that can be converted to battery-grade products at scale.

As a practical matter, implementation of the disclosed ZTIS-01-LiCPM-carbonation train provides a scalable framework for producing battery-grade Li₂CO₃ from high-salinity aqueous feeds, including low-grade or impurity-rich resources where thermal concentration is slow, site-limited, or environmentally contentious. More broadly, this approach offers a translation pathway from laboratory selectivity demonstrations to industrially actionable product streams, because it embeds concentration and product qualification into the core process logic, enabling systematic optimization of energy use, materials durability, and impurity management toward real manufacturing specifications. A particularly beneficial example follows.

The configurations discussed above depict a modified zirconium-titanate ion-sieve sorbent (ZTIS-01) employed as the solid-phase capture medium to enable highly selective lithium extraction from high-salinity aqueous feeds. ZTIS-01 is a zirconium titanate-based inorganic framework typically obtained by controlled delithiation/protonation of a lithium zirconium-titanate precursor, generating exchangeable protonic sites within the zirconium-titanate lattice and/or interlayer domains. These proton-active sites promote Li⁺ uptake through a reversible ion-exchange mechanism, in which Li⁺ is preferentially inserted into crystallographically favorable coordination environments while H⁺ (or other charge-compensating species) is released to the aqueous phase. Because selectivity is governed primarily by the structural effect rather than bulk electrostatic partitioning, ZTIS-01 can maintain lithium affinity in the presence of abundant competing ions (e.g., Na⁺, Mg²⁺, and Ca²⁺) typical of brines. It should be understood by those skilled in the art that the present invention is not limited to any specific zirconium-titanate phase, synthesis route, particle morphology, or physical form. Any zirconium/titanate-based sorbent capable of selective, regenerable Li⁺ exchange under brine-relevant ionic strength shall be regarded as an equivalent.

A Li-ion-conducting polymer-based membrane (LiCPM) or cation exchange membrane (CEM) may be employed to enable ultra-fast Li-ion concentration. The functional polymer, which contains single or multiple functional groups, such as amine groups, sulfo groups, or other cation-active moieties that locate either within each repeating unit or randomly distributed along the polymer backbone, facilitates Li-ion transport through an ion-exchange mechanism. The CEM may have cation-active moieties including anionic fixed sites, chemically tethered to a backbone of the polymer. It should be understood by those skilled in the art that although certain embodiments employ cation-active moieties polymers, the present invention is not limited to any particular commercial product or specific side-chain structure. Such a polymer membrane with cation-active moieties is basically a solid material that can conduct cations because it has chemical groups built into the polymer that can donate and transport cations. Any material capable of enabling the transport of cations shall be regarded as an equivalent of the present approach.

An experimental use case of the disclosed approach demonstrates an integrated, low temperature pathway that couples selective adsorption, rapid non-thermal concentration, and direct conversion to lithium carbonate. A ZTIS-01 was applied to a challenging 5 L feed containing 200 mg L⁻¹ Li⁺, 18,600 mg L⁻¹ Na⁺, 18,000 mg L⁻¹ Mg²⁺, and 36,000 mg L⁻¹ Ca²⁺. The adsorption and stripping steps generated similar volume of stripping solution within ~4 h, with limited co-extraction (Li⁺ 195.3 ppm, Na⁺ 5.51 ppm, Mg²⁺ 2.53 ppm, Ca²⁺ 1.97 ppm). The stripping solution was then concentrated to 40 mL in 150 min using a lithium-ion-conducting polymer membrane, yielding a conversion-ready stream (Li⁺ 24,076.56; Na⁺ 680.25; Mg²⁺ 247.13; Ca²⁺ 241.82). Finally, precipitation produced Li₂CO₃ with >90% overall recovery efficiency and 99.93% purity in ~4 h. Together, these results establish a practical end-to-end route from complex low-grade brines to battery-grade lithium carbonate within hours, without relying on thermal evaporation.

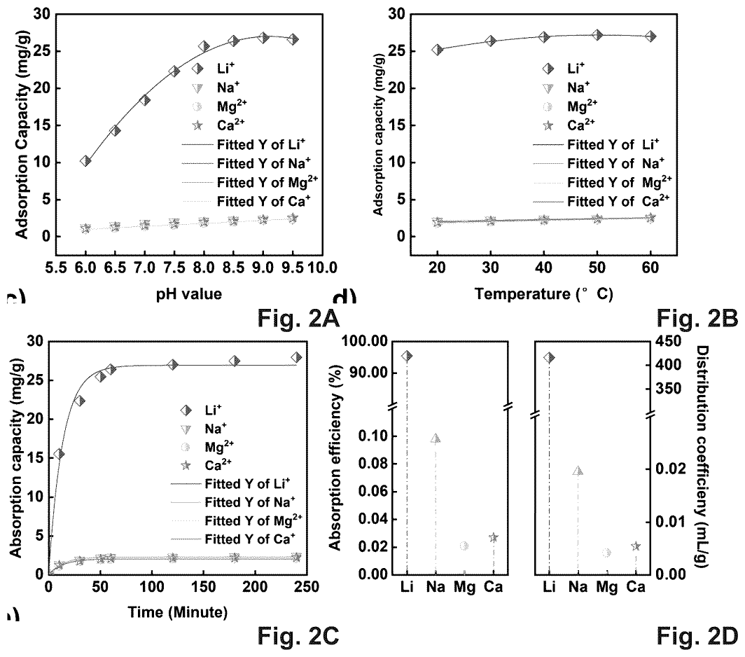

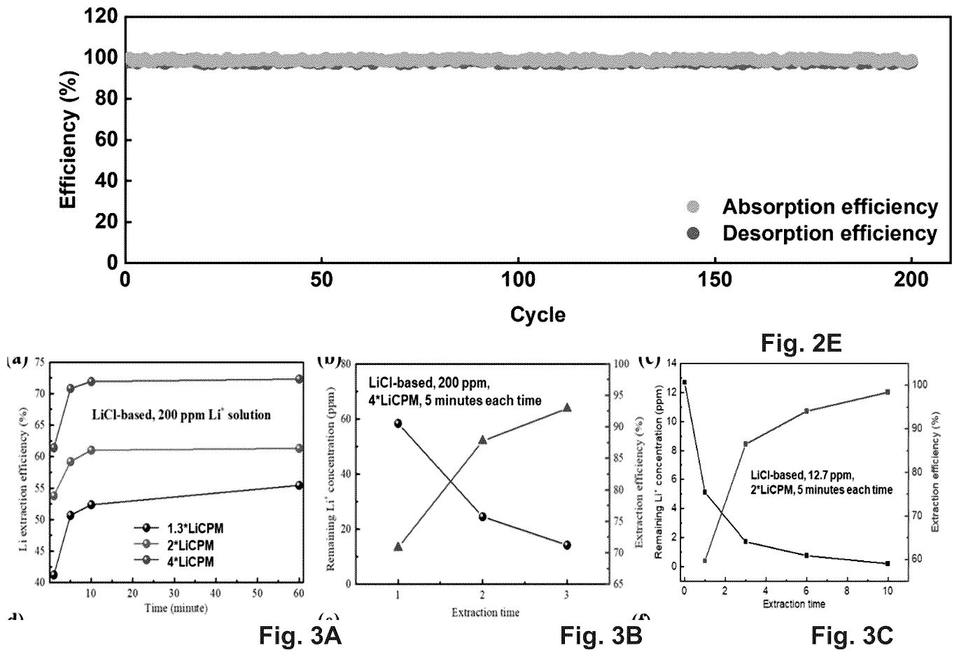

FIGS. 2A-2E show adsorption performance of zirconium-titanate based lithium-ion sieves over a range of pH values. A particular use case investigates adsorption behaviors of ZTIS-01 in the synthetic brine with 20 mg·L⁻¹ of Li⁺, 18,600 mg·L⁻¹ of Na⁺, 36,000 mg·L⁻¹ of Ca²⁺, and 18,000 mg·L⁻¹ of Mg²⁺.

Referring to FIGS. 1-2E, since solution pH strongly influences cation uptake on zirconium-titanate based lithium-ion sieves, adsorption performance of ZTIS-01 were evaluated over a range of pH values. Since Mg(OH)₂ can precipitate at pH >8.8, brine solutions adjusted to alkaline conditions were filtered prior to adsorption to avoid artifacts associated with hydroxide precipitation. Referring to FIGS. 2A-2E in FIG. 2A, the adsorption capacities of Li⁺, Na⁺, Ca²⁺, and Mg²⁺ increased with pH up to pH 8.5, while further increases in pH produced little additional improvement. Accordingly, subsequent adsorption experiments were conducted within pH 8-9. Temperature also affects adsorption. As shown in FIG. 2B, the Li⁺ adsorption capacity increased markedly as temperature was raised from 20 to 50° C., whereas only slight increases were observed for Nat, Ca²⁺, and Mg²⁺. This trend suggests that elevated temperature accelerates the Li⁺/H⁺ ion-exchange process in ZTIS-01 by enhancing mass transfer and lowering kinetic barriers. In addition, higher temperature increases the frequency of ion-surface collisions and can help overcome repulsive interactions at the interface, thereby improving overall uptake. Adsorption kinetics were further investigated at constant pH (8-9), fixed initial brine composition, 30° C., and an adsorbent dosage of 5 g·L⁻¹ (FIG. 2C). The Li⁺ adsorption capacity increased rapidly during the first 30 min and approached a plateau after ~1 h (25.15 mg·g⁻¹), ultimately reaching a maximum of 28.53 mg·g⁻¹. In contrast, the maximum adsorption capacities of Na⁺, Ca²⁺, and Mg²⁺ were only 1.53, 1.37, and 2.87 mg·g⁻¹, respectively, highlighting the strong preference of ZTIS-01 for Li⁺ even under highly saline conditions. To quantify selectivity more rigorously, adsorption capacity, distribution coefficient, and separation factors were calculated for Li⁺ and competing cations in the same brine, shown in FIG. 2D. The equilibrium partitioning followed the order Mg²⁺<Ca²⁺<Na⁺<<Li⁺, confirming the strong Li⁺ selectivity of ZTIS-01. Separation factors for Li⁺ relative to Na⁺, Mg²⁺, and Ca²⁺ were all much greater than unity; notably, the Li/Mg, Li/Ca, and Li/Na separation factor reached 9.90×10⁴, 7.70×10⁴, and 2.12×10⁴, respectively, indicating particularly effective discrimination against Mg²⁺, Ca²⁺, and Na⁺. This behavior is consistent with the “ion-memory” effect of zirconium-titanate ion sieves and the unfavorable insertion of competing ions with larger effective ionic radii and/or higher hydration free energies compared with Li⁺. In particular, it is expected that the ZTIS-01 has a selectivity for adsorbing a greater quantity of the lithium than calcium, magnesium and sodium.

Desorption was performed by acid washing. Over an HCl concentration range of 0.01-1 M, ZTIS-01 exhibited high delithiation efficiency (95-99%) at room temperature using a solid-to-liquid ratio of 50 g·L⁻¹, demonstrating facile regeneration. Given that recyclability is critical to practical deployment and cost effectiveness, the cyclic adsorption-desorption performance was evaluated in brine. As shown in FIG. 2E, the Li⁺ adsorption efficiency remained ~95% over 200 cycles, while uptake of the other cations remained low (typically 1-3 mg·g⁻¹). Theoretically, the lifespan for ZTIS can reach at least 1000 cycles without performance degradation. Notably, Li⁺ capacity and selectivity showed minimal change between the first and subsequent cycles, indicating good structural stability of ZTIS-01 under repeated operation. The adsorbed cations could be effectively desorbed using HCl, and the desorption yields of Li⁺, Na⁺, Ca²⁺, and Mg²⁺ reached 98.1%, 92.5%, 90.3%, 91.8%, and 95.3%, respectively, under the tested conditions. Any suitable acid may be employed; particular configurations employ hydrochloric acid or sulfuric acid.

To realize the goal of concentrating the low concentration Li-ion solution after selective leaching within an ultra-short time, LiCPM 130 (FIG. 1) was applied as an efficient Li-ion conductor. Based on its Li-ion storage capacity, 1 to 4 times the equivalent weight (EW, based on the Li-ion amount in the low-concentration Li-ion solution) of LiCPM was used for fundamental study. LiCPM was immersed in the low-concentration Li-ion solution 124′ with a time range of 1 minute to 1 hour with agitation (3-5 minutes are significant enough to be efficient in the next section). A low-concentration Li-ion solution composed of LiCl, Li₂SO₄, LiOH, or other Li-based compositions and mixtures can be used as input solutions for this step. The LiCPM immersing in the solution will spontaneously capture the Li-ions from the solution by ion exchange and become a lithiated-LiCPM after taking out from the solution.

The lithiated-LiCPM was then used for delithiation and releasing the captured Li-ions, realizing the Li-ion concentration target. A delithiation solution 150 was used to immerse the lithiated-LiCPM and extract the Li-ions from the lithiated-LiCPM by ion exchange with agitation. The delithiation solution can be a strong acid with moderate or high concentration (e.g., a H₂SO₄ solution with a concentration from 0.5 M to 5 M). The process of delithiation takes less than 1 minute to accomplish. As a result, Li-ions can be concentrated and the delithiated-LiCPM can be used again for Li-ion capture.

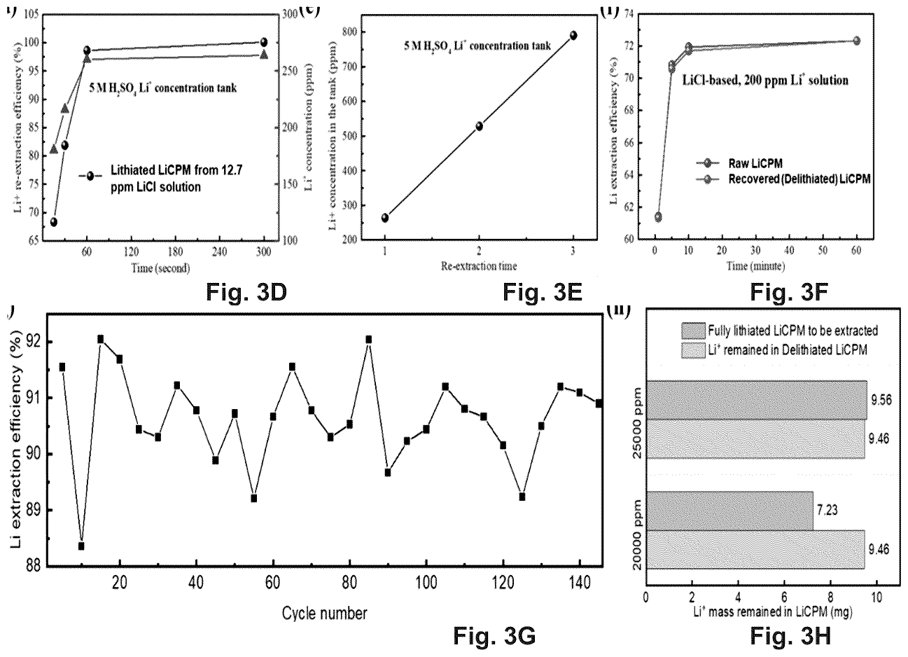

FIGS. 3A-3H show use cases of extracting and releasing lithium using the lithium-ion-conducting polymer-based membrane (LiCPM). Referring to FIGS. 3A-3H, FIG. 3A depicts a study of a typical LiCPM usage in Li⁺ extraction from LiCl;

FIG. 3B shows a study of Li⁺ concentration in the extracted solution with extraction times from LiCl solution;

FIG. 3C shows a study of Li⁺ concentration in the extracted solution with extraction times from LiCl solution (ultra-low concentration solution feedstock);

FIG. 3D depicts de-lithiation of lithiated LiCPM in the Li⁺ concentration tank.

FIG. 3E shows a multi-times de-lithiation study;

FIG. 3F shows a comparison of extraction efficiency for raw and recovered LiCPM;

FIG. 3G depicts cycle durability test of LiCPM in Li⁺ extraction; and FIG. 3H discloses an enrichment limit test of the final concentrated Li⁺ solution. A typical LiCPM 130 was selected for fundamental study and feasibility evaluation of the concentration step. By applying a 4-times LiCPM (one-time means the amount of H⁺ in the LiCPM equals to the Li⁺ in the solution) sheet stack, 71% of the Li⁺ could be captured in 5 minutes (FIG. 3A), and the efficiency remained at 72% after 1 hour, indicating a fast Li⁺ capture efficiency. By repeatably using fresh LiCPM to capture the Li⁺ in the same 200-ppm-level LiCl solution, 92.9% of Li⁺ can be captured within 3 times (FIG. 3B). Impressively, at an ultra-low concentration of 12.7 ppm of Li⁺, an extraction efficiency of 98.4% can be achieved by using 2 times LiCPM and 10-time extraction (50 minutes), as shown in FIG. 3C. To get the concentrated Li⁺ solution from the lithiated LiCPM (Li-LiCPM), the Li-LiCPM sheets were immersed in 20 ml of 5M H₂SO₄ solution (Li⁺ concentration solution). As shown in FIG. 3D, it only took 60 seconds to re-extract the Li⁺ from the Li-LiCPM (from a 500 ml 12.7 ppm LiCl solution) with an efficiency of 98.5% and to form a condensed Li⁺ concentration of 264 ppm. Two more Li-LiCPM stacks with the same amount of captured Li⁺ were followed for the re-extraction process in FIG. 3E, a highly linear increment of the Li⁺ concentration could be delivered, and the solution reached a Li⁺ concentration of 790 ppm without evaporating solvents, which is over 60 times higher than the initial concentration in 3 hours.

Moreover, the recovered LiCPM from the acid re-extraction process was reused for Li-extraction and presented a consistent performance in FIG. 3F, verifying the reusability of the LiCPM sheets. FIG. 3G showed the cycle performance of LiCPM in Li⁺ concentration, 5-cycle extraction was applied for each low-concentration solution (~20 ppm), and after 145 cycles, there is no sign of extraction efficiency decrement, indicating the ultra-high stability of LiCPM. Theoretically, referring to its performance in fuel cells and electrolyzers, LiCPM can maintain its chemical stability for at least 30,000 hours², equivalent to a life cycle of 360,000 times of Li⁺ extraction in this study. Additionally, to explore the maximum Li⁺ concentration value that can be realized through the LiCPM-mediated approach, independent studies using ultra-high Li⁺ concentration solution were conducted, as shown in FIG. 3H. The fully lithiated LiCPM was immersed to a 20,000 ppm and 25,000 ppm Li₂SO₄ solution with extra 2 M H₂SO₄. With an initial Li⁺ mass of 9.46 mg, the delithiated LiCPM in 20,000 ppm solution delivered a remaining Li⁺ mass of 7.23 mg, indicating the solution still possesses a Li⁺ storage capacity. However, the fully lithiated LiCPM from the 25,000 ppm solution delivered similar input and output Li⁺ mass, indicating that a diffusion balance was reached and the theoretical maximum concentration should be around 25,000 ppm through our LiCPM-mediated approach. In summary, A LiCPM 130 as formed in the disclosed approach was verified to possess the ability to conduct Li⁺ with an ultra-short time (3-5 minutes per cycle), achieving super-efficient Li⁺ concentration function without any forms of thermal application, such as solvent evaporation.

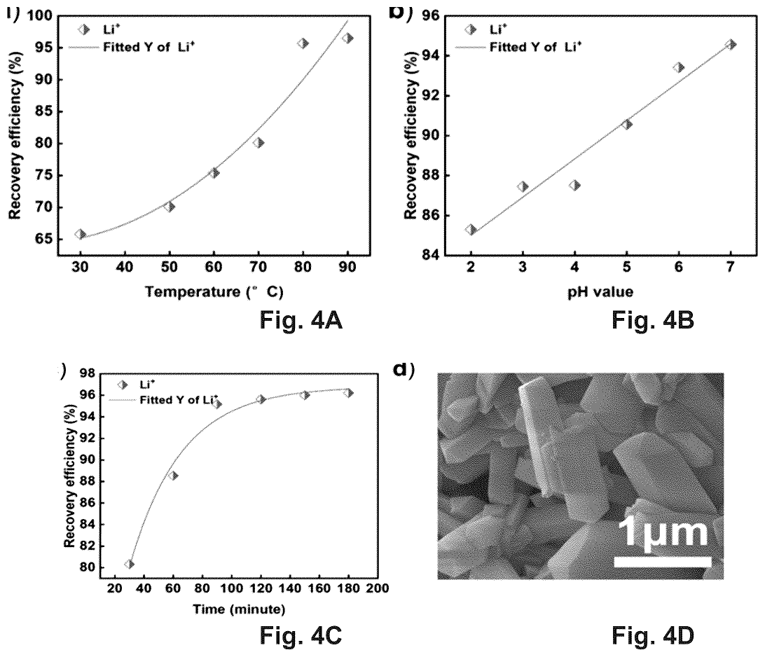

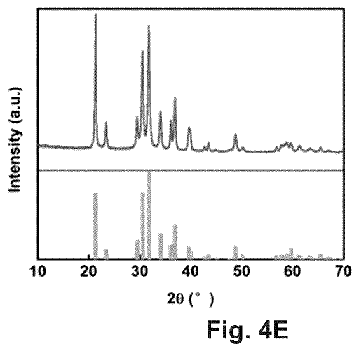

FIGS. 4A-4E clarify the dependencies of precipitation performance exhibited clear on temperature, pH, and time. Referring to FIGS. 4A-4E, to enable high-yield production of battery-grade lithium carbonate from the Li-enriched stripping solution, Li₂CO₃ was precipitated from a Li₂SO₄/H₂SO₄ mixed aqueous stream via controlled neutralization followed by carbonate addition. Specifically, the acidic Li₂SO₄/H₂SO₄ solution was first adjusted to the target pH using NaOH, thereby suppressing excess acidity that would otherwise consume carbonate and reduce Li₂CO₃ supersaturation. After pH conditioning, Na₂CO₃ was introduced to trigger Li₂CO₃ nucleation and growth. The impacts of precipitation temperature, pH, and residence time were systematically evaluated to identify conditions that maximize lithium recovery while maintaining product phase purity.

FIG. 4A shows that increasing the precipitation temperature markedly improved lithium recovery: the recovery efficiency increased from 65.83% at 30° C. to 80.15% at 70° C. and reached >95% at 80-90° C. (95.71% and 96.52%, respectively), indicating that elevated temperature accelerates precipitation kinetics and facilitates more complete conversion of soluble lithium to Li₂CO₃. Solution pH depicted in FIG. 4B also played an important role. Recovery increased from 85.31% at pH 2 to >90% at pH 5 (90.57%), and further improved to 93.42-94.57% at pH 6-7, consistent with reduced carbonate loss to acid neutralization and enhanced effective carbonate activity at moderately acidic to near-neutral conditions. Additionally, FIG. 4C demonstrates that longer precipitation time improves recovery and approached a plateau behavior: lithium recovery increased from 80.32% at 30 min to 88.54% at 60 min, exceeded 95% after 90 min (95.17%), and stabilized at ~96% after 120-180 min (95.63-96.21%). FIG. 4D depicts Scanning Electron Microscope (SEM) images for recovered Li₂CO₃, and FIG. 4E demonstrates an X-ray diffraction (XRD) pattern for recovered Li₂CO₃, Collectively, these results indicate that a practical operating window for high recovery is achieved at elevated temperature (≥80° C.) with sufficient residence time (≥90 min) and moderated pH (typically ≥5), balancing rapid kinetics with efficient carbonate utilization.

TABLE I
ICP test results (mg/kg)

| | Mg | Na | Si | P | S | Ca | Ti | Mn | Fe | Co | Ni | Cu | Zn | Purity % |
|---|---|---|---|---|---|---|---|---|---|---|---|---|---|---|
| C-Li₂CO₃ | 40 | 254 | 1176 | 90 | 74 | / | / | 32 | 40 | 18 | 46 | / | 54 | 99.82% |
| R-Li₂CO₃ | 52 | 152 | 854 | 95 | 98 | / | / | / | 52 | / | / | / | / | 99.93% |

The recovered lithium carbonate precipitation consisted of microscale particles, which are advantageous for downstream filtration and washing. Phase identification by X-ray diffraction (XRD) confirmed that the diffraction pattern of the recovered product matched well with that of virgin Li₂CO₃ (PDF card #00-022-1141), indicating successful formation of the target crystalline phase without detectable secondary phases. To evaluate chemical purity, both recovered and virgin Li₂CO₃ were dissolved and analyzed by ICP-OES, as shown in Table I. The commercial Li₂CO₃ exhibited a purity of 99.82%, while the recovered Li₂CO₃ reached 99.93%, demonstrating that the precipitation and post-treatment protocol can produce battery-grade lithium carbonate with purity comparable to, or exceeding, the commercial benchmark. These findings validate precipitation from Li₂SO₄/H₂SO₄ streams as an effective downstream conversion step and provide a clear set of operating guidelines for high-yield, high-purity Li₂CO₃ production.

An alternate configuration and approach for lithium wastewater treatment presents an electrodialysis process as an alternative method of Li extraction, enabled by a selective membrane. The polymer based membrane may be a sulfonic-acid-based polymer (SABP). The membrane can include a solid-state electrolyte (SSE), such as lithium lanthanum zirconium oxide (LLZO), lithium aluminum titanium phosphate (LATP).

The disclosed approach sets out a practical and feasible approach to develop an energy-efficient, product-oriented route to selectively extract and concentrate lithium from high-salinity aqueous feeds and directly convert it into battery-grade lithium carbonate. We tested the hypothesis that coupling a robust ion-sieve capture step with a non-thermal, concentration step can deliver a carbonate-ready intermediate stream that enables high-yield precipitation while maintaining tight impurity control.

Overall, the results demonstrate that the modified zirconium-titanate ion-sieve sorbent can sustain strong lithium preference under brine-relevant ionic strength and challenging co-ion backgrounds, supporting reliable lithium uptake and regeneration when operated within an appropriate pH and desorption window. In parallel, the lithium-ion-conducting polymer membrane provides a rapid and controllable pathway for lithium capture/release and stream concentration without relying on energy-intensive evaporation, thereby shifting the concentration step from a generic utility operation to a chemistry-aware, impurity-constrained unit operation. Importantly, integrating these components into a unified ZTIS-01-LiCPM-carbonation train validates a complete feedstock-to-product workflow that achieves near-quantitative lithium recovery and battery-grade carbonate quality while reducing downstream burden from multivalent impurities and improving process controllability. Beyond a single flowsheet demonstration, this work contributes a broader design principle for DLE: defining separation and concentration windows from end-product specifications (purity targets, impurity envelopes, and precipitation compatibility) can materially improve both performance and manufacturability, enabling economically meaningful operation across lower-grade and more compositionally complex resources.

In sum, this integrated extraction-concentration-recovery strategy provides a scalable blueprint for next-generation DLE that advances lithium recovery from selective separation and non-thermal concentration toward consistent, product-specification-driven manufacturing of battery-grade Li₂CO₃.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A method of generating purified lithium, comprising:
adsorbing lithium onto a lithium-selective solid medium from an aqueous stream;
flowing a first acid across the lithium-selective solid medium for extracting a low concentration lithium solution;
contacting the low concentration lithium solution with a lithium-ion-conducting polymer membrane for extracting the lithium onto the lithium-ion-conducting polymer membrane in a capture step;
contacting a second acid with the lithium-ion-conducting polymer membrane for extracting a concentrated lithium solution in a release step;
concentrating the low concentration lithium solution by performing one or more cycles of the capture step and the release step using the lithium-ion-conducting polymer membrane to reach a target lithium concentration; and
recovering lithium from precipitation of the concentrated lithium solution.

2. The method of claim 1 further comprising generating the aqueous stream from a harvested brine solution with dissolved lithium including one or more of a brine and a Li-containing wastewater.

3. The method of claim 2 wherein extracting the low concentration lithium solution further comprises passing the brine through a column of solids responsive to lithium for forming an adsorbed lithium medium.

4. The method of claim 1 wherein the solid medium is a zirconium-titanate ion-sieve sorbent.

5. The method of claim 4 further comprising forming the lithium selective solid medium by doping a titanium oxide with zirconium or other elements.

6. The method of claim 1 wherein the first acid comprises an aqueous acid solution selected from the group consisting of hydrochloric acid (HCl), sulfuric acid (H₂SO₄), nitric acid (HNO₃), phosphoric acid (H₃PO₄) and formic acid (HCOOH).

7. The method of claim 1 wherein the second acid comprises an aqueous acid solution selected from the group consisting of hydrochloric acid (HCl), sulfuric acid (H₂SO₄), nitric acid (HNO₃), phosphoric acid (H₃PO₄), formic acid (HCOOH).

8. The method of claim 1 wherein the low concentration lithium solution has a concentration between 0.001-0.1 M.

9. The method of claim 1 wherein the concentrated lithium solution has a concentration between 0.5 and 5.0 M.

10. The method of claim 1 further comprising forming the lithium-ion-conducting polymer membrane includes selecting the polymer-based membrane based on an ability to exchange lithium ions with an aqueous solution and to release lithium ions upon contact with an acid solution, the acid solution including one or more of H₂SO₄, HCl, HNO₃, H₃PO₄, and HCOOH.

11. The method of claim 1 wherein forming the polymer-based membrane includes identifying a cation exchange membrane having cation-active moieties including anionic fixed sites, chemically tethered to a backbone of the polymer.

12. A system for harvesting lithium, comprising:
an adsorption column containing a lithium-selective solid medium configured to adsorb lithium from a brine;
a first acid source fluidly coupled to the adsorption column and configured to contact the lithium-selective solid medium with a first acid solution to produce a low-concentration lithium solution;
a membrane module comprising a lithium-ion-conducting polymer membrane fluidly coupled to receive the low-concentration lithium solution, wherein the membrane module is configured to load lithium into the lithium-ion-conducting polymer membrane;
a second acid source fluidly coupled to the membrane module and configured to contact the lithium-ion-conducting polymer membrane with a second acid solution to produce a concentrated lithium solution; and
a precipitation reactor fluidly coupled to receive the concentrated lithium solution and configured to precipitate lithium carbonate therefrom.

13. The system of claim 12 wherein the precipitated lithium is lithium carbonate of at least 99.5% purity.

14. The system of claim 12, wherein the adsorption column comprises a packed bed of the lithium-selective solid medium and includes a distributor configured to provide upflow or downflow liquid distribution through the packed bed.

15. The system of claim 12, wherein the membrane module comprises a membrane stack including a plurality of lithium-ion-conducting polymer membranes arranged in parallel flow channels to increase membrane area.

16. The system of claim 12, further comprising a recirculation loop fluidly coupled to the membrane module, the recirculation loop including a pump and configured to recirculate the low-concentration lithium solution through the membrane module until a target lithium concentration is reached.

17. The system of claim 12, further comprising an inline filter positioned upstream of the membrane module and configured to remove suspended solids from the low-concentration lithium solution.

18. The system of claim 12, wherein the precipitation reactor is fluidly coupled to a pH control unit comprising a base reservoir and a pH sensor and is configured to adjust the pH of the concentrated lithium solution prior to or during precipitation.

19. The system of claim 12, wherein the system is configured to concentrate lithium without thermal evaporation by transferring lithium into and out of the lithium-ion-conducting polymer membrane via ion exchange with the first and second acid solutions.

20. The system of claim 12, wherein the lithium-selective solid medium and the lithium-ion-conducting polymer membrane are each configured for repeated reuse for at least 200 cycles of lithium loading and lithium release.

21. The system of claim 12, further comprising a regeneration loop fluidly coupled to at least one of the adsorption columns and the membrane module, the regeneration loop configured to deliver an acid solution to release lithium and deliver a rinse solution to restore the lithium-selective solid medium and/or the lithium-ion-conducting polymer membrane for subsequent cycles.

22. The system of claim 20, wherein the system is configured such that a lithium recovery efficiency after the repeated reuse is maintained within +20% of an initial lithium recovery efficiency.

23. A lithium carbonate compound precipitated from an acid wash of polymer-based membrane with adsorbed lithium resulting from leachate of a brine immersed in a zirconium-titanate ion-sieve sorbent.

24. The system of claim 13, wherein the brine comprises a lithium-bearing aqueous feed stream selected from natural brine, geothermal brine, produced water from hydrocarbon production, lithium-containing wastewater, and synthetic brine.

25. The system of claim 24, wherein the lithium recycling wastewater comprises an aqueous stream generated from hydrometallurgical processing of lithium-containing materials.

26. The system of claim 24, wherein the produced water comprises an aqueous stream co-produced with oil and/or gas and containing lithium and at least one of sodium, calcium, magnesium, or chloride ions.
